(19) United States
(12) Patent Application Publication
(10) Pub. No.: US 2010/0165099 A1
(43) Pub. Date: Jul. 1, 2010

(54) Antiglare system for a vehicle

(76) Inventors: Reiner Marchthaler, Gingen (DE); Hans-Dieter Bothe, Seelze (DE); Hoang Trinh, Ditzingen (DE); Heiko Freienstein, Weil der Stadt (DE); Thomas Engelberg, Hildesheim (DE); Matthias Wellhoefer, Stuttgart (DE)

Correspondence Address: KENYON & KENYON LLP, ONE BROADWAY, NEW YORK, NY, 10004, US

(21) Appl. No.: 10/563,992

(22) PCT Filed: Jul. 22, 2004
(86) PCT No.: PCT/DE04/01628

§ 371 Date: May 31, 2006

(30) Foreign Application Priority Data
Aug. 4, 2003 (DE) 103 35 600.2
Feb. 17, 2004 (DE) 10 2004 007521.2

(51) Int. Cl. H04N 7/18

(52) U.S. Cl. 348/135; 348/E07.091

(57) ABSTRACT

An antiglare system in a vehicle includes a device for controlling antiglare means. The device includes at least one image acquisition means. The antiglare means is controlled as a function of a first signal of the image acquisition means. The light intensity in the passenger compartment of the vehicle is taken into account in controlling the antiglare means.

### FIELD OF THE INVENTION

The present invention relates to an antiglare system for a vehicle.

### BACKGROUND INFORMATION

Published German patent document DE 100 12 799 describes a device for activating an antiglare means as a function of an illumination of a vehicle occupant's face.

### SUMMARY

The device according to the present invention for activating an antiglare means in a vehicle has the advantage over the prior art that it takes into account the head position, and thus the posture, of the vehicle occupant when activating the antiglare means. In addition, a face cover may advantageously be taken into account. In most cases, this face cover is a pair of sunglasses, which cause the antiglare means not to be activated, since the vehicle occupant is sufficiently protected from glare by the sunglasses. Antiglare means may be understood here as a mechanical antiglare means such as blinds or shutters, which is selectively unrolled to a greater or lesser degree when operated, covering the windows of the vehicle to a greater or lesser degree and thus at least reducing a glare. However, an antiglare means as defined in the present invention also includes means integrated into the window panes themselves. For example, it includes an electrochromatic glass whose transmission properties may be altered by applying a voltage. The glass may thus be darkened, thus at least reducing the glare for the vehicle occupants. An antiglare means is understood in general as a device for darkening different windows in a vehicle. The different windows may also be darkened independently. For example, if it has been determined that glare is due to the rear view mirror, the corresponding windows are darkened, but not those through which the light reflected by the rear view mirror does not enter the vehicle. All in all, the vehicle occupants are thus better protected from glare, which improves driving safety and driving comfort.

Automatic setting and adjustment of the antiglare system alleviates the burden on the vehicle occupants, in particular on the vehicle driver. The use of electrochromatic glass or other transparent materials having adaptive transmission properties makes direct and simple integration of the antiglare means into all vehicle windows possible. The use of an antiglare means also improves the readability of a head-up display if the vehicle is so equipped. The device according to the present invention makes brightness measurement using photocells unnecessary. Sun screens may also be avoided. Avoiding sun screens provides more options for integrating image acquisition sensors, i.e., in particular the option of optical detection of the vehicle's passenger compartment. The image quality of image acquisition and deep image acquisition sensors in the passenger compartment is improved by suppressing or reducing the influence of external light. The use of an antiglare system in the vehicle windows, in particular the lateral windows, makes a dimmable design of the outside mirror unnecessary. The same holds true for the design of the inside mirrors.

It is advantageous in particular that the eye position of the vehicle occupants is taken into account when activating the antiglare means. Setting adaptive antiglare protection with the highest efficiency is made possible when the instantaneous eye position is known. Information about the class of occupants may also be used for activating the antiglare means. It is furthermore advantageous that the image acquisition means for monitoring the vehicle occupants may be a stereo video sensor for passenger compartment monitoring. In particular, the device may be linked to a restraint system which uses such a stereo video sensor to recognize and classify the vehicle occupants. An additional use is thus created for a passenger compartment monitoring system.

It is furthermore advantageous that a shadow edge is identified when the signal is generated for determining the glare. This provides more accurate information about the degree of glare. In addition, it allows the antiglare means to be better activated. The light intensity may also be used for this purpose. In addition, the first signal may advantageously also be generated as a function of the activation of the antiglare means. This makes a regulation mechanism possible for monitoring the effects of activation of the antiglare means, which results in fine regulation of the antiglare means. Brightness regulation of the image acquisition means may be provided as a function of the device's signal. The quality of the image detected by the image acquisition means may thus be improved. A model of the passenger compartment may also be taken into account when activating the antiglare means to optimize the lighting conditions when adjusting the antiglare means. A signal of an additional sensor system may also be taken into account when activating the antiglare means. This includes e.g., sensors for measuring the steering angle or the rate of change of the steering angle, as well as video sensors for detecting the surroundings of the vehicle. Other environmental sensor types are also possible here. For example, the dynamics of the regulation unit may be adjusted via the vehicle velocity and via the external sensor system, which is highly advantageous in particular in city driving or in tunnels. Steering angle detection allows optimum adjustment of the antiglare means when cornering.

### BRIEF DESCRIPTION OF THE DRAWINGS

FIG. 1 shows a block diagram of a first example embodiment of the device according to the present invention.

FIG. 2 shows a block diagram illustrating some of the component functions of an example embodiment of the device according to the present invention.

FIG. 3 shows a block diagram of a third example embodiment of the device according to the present invention.

FIG. 4 shows a block diagram of a fourth example embodiment of the device according to the present invention.

FIG. 5 shows a block diagram of a fifth example embodiment of the device according to the present invention.

FIG. 6 shows an example of the actuator system of the antiglare means.

FIG. 7 shows a schematic diagram of the electrochromatic glass.

FIG. 8 shows an example of a vehicle window having a selectively absorbent layer.

FIG. 9 shows an example of a vehicle window having a controllable, selectively absorbent layer.

### DETAILED DESCRIPTION

The present invention provides a device for activating an antiglare means, which results in adaptive protection of the vehicle occupants against direct or indirect glare as a function of their belonging to a certain class of individuals, e.g., adult occupants or child in a child seat, their posture, their three-dimensional head position, their three-dimensional eye position with respect to the passenger compartment geometry, their eye position in the image and their viewing direction, and as a function of the intensity of the glare and the areas exposed to glare. When the antiglare system is automatically set and adjusted, functions provided by optical image acquisition sensors and active image acquisition sensors, for example, detection, locating and tracking of occupant heads and eyes for seat occupancy classification and the determination of the occupants' postures may be used, this information also being provided for adaptive activation of motor vehicle restraint systems. By suitably setting the antiglare system, the lighting conditions in the passenger compartment may in turn be optimally adjusted for the above-named optical image acquisition and deep image acquisition sensors.

When glass or transparent materials having adjustable transmission properties which may be integrated into the vehicle windows are used, such as electrochromatic glass, the present invention provides good readability of head-up displays in the vehicle, for example, on the front windshield, regardless of the incidence of light and for any postures, head positions and viewing directions of the vehicle occupants.

The present invention allows conventional sun screens to be replaced by novel antiglare systems which may be integrated into the vehicle windows and whose light-transmission properties are adjustable, or which may be designed as movable blinds or shutters.

The present invention also relates in general to glare protection of all vehicle windows, i.e., the front windshield as well as the side windows, the rear window, and, if present, the sunroof window.

The antiglare means such as glass having adaptive transmission properties may be adjusted gradually or stepwise from totally transparent to semi-transparent, while the visibility of the road must always be ensured. In addition, the antiglare means may be composed of a plurality of individually activatable protection elements.

In addition to automatic setting and adjustment, the antiglare means may be switched over to manual operation using suitable operating elements, for example, via a switch.

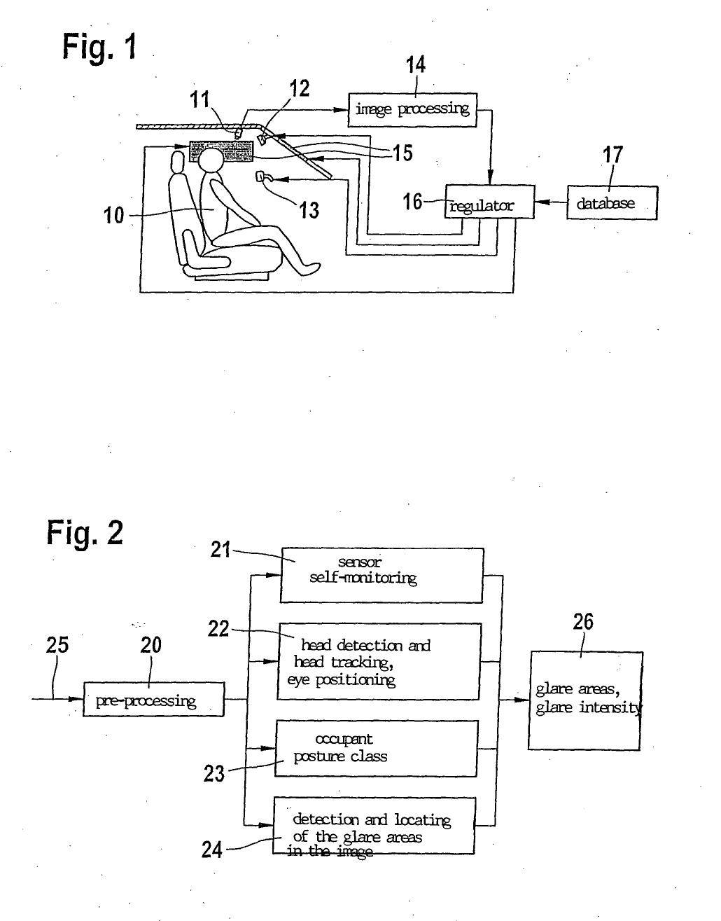

FIG. 1 shows a first block diagram of the device according to the present invention. A vehicle occupant 10 in a vehicle seat is detected by an image acquisition sensor 11, the eye position and the three-dimensional head position, as well as the posture of the vehicle occupant being detected in particular. To determine the antiglare protection, the light intensity on the face of vehicle occupant 10 is detected. Glare may result not only from direct light from the front or a side but also from indirect light via a rear-view mirror 12 and external mirror 13. The vehicle has an adaptive antiglare means 15 in the vehicle window for glare protection. Adaptive antiglare means 15 is activated by regulator 16, which activates the antiglare means as a function of a signal from an image processing means 14, which in turn processes the signals of image acquisition sensor 11. Regulator 16 receives sensor status information regarding the occupant class, posture, head position, eye position, and viewing direction of the vehicle occupant, as well as glare zones and glare intensities from image processing means 14. In addition, regulator 16 uses data from a database 17, which includes parameter sets and characteristic curves for activating the antiglare system. Image processing means 14, regulator 16, and database 17 may all be integrated in a control unit of the vehicle.

Image acquisition sensor 11 is a video sensor here, which detects the vehicle's passenger compartment at a wide angle. This allows not only the front seats, but also optionally the back seats to be detectable. The side windows that may be relevant for the glare, as well as the inside and outside rear-view mirrors, may also be included in the detection range of sensor 11. The images delivered by sensor 11 are supplied to image processing block 14 as input quantities. The algorithms required for activating the antiglare system according to the present invention are implemented in image processing block 14. This essentially includes the following algorithms: Image pre-processing, classification of the occupants in their postures, detection, locating and tracking of heads, eye location and sensor self-monitoring. In addition, detection, locating of the glare zones, and determination of the intensity in these glare zones are provided. For example, excessively or insufficiently illuminated image zones may be detected and located using this method. This includes the location of shadow edges, the measurement of absolute intensity, and the combination of these two parameters, as well as the effect of slight changes in the sun screen or the antiglare means and appropriate follow-up of the confirmation of or response to the movement of the shadow edge.

The output quantities of image processing block 14 may include the occupant class and the occupant posture, the head position, the eye position and the viewing direction of the occupants, but, in the simplest case, of the driver only, the glare zones, the glare intensity, and the sensor status. The above-mentioned output quantities of image processing block 14 as well as the parameter sets and characteristic curves from a database 17 form the input quantities of regulator 16, which is responsible for setting and adjusting actuator system 15 of the antiglare system. This essentially includes the adaptive antiglare means on the vehicle windows, for example, windows made of electrochromatic glass, blinds or shutters, dimmable mirrors, for example, mirrors made of electrochromatic glass. If the antiglare means includes electrochromatic glass, its transmission properties are modified by applying a voltage, i.e., the glass may thus be darkened, for example. FIG. 1 shows the antiglare means on the front windshield and on the side window as an example. In principle, however, all other vehicle windows may also be thus equipped.

In addition to antiglare regulation, brightness regulation of the image acquisition sensor may also be performed to improve its image quality.

FIG. 2 shows a block diagram illustrating some of the component functions of an example embodiment of the device according to the present invention. Stereo images 25 of image acquisition sensor 11 are supplied to pre-processing means 20. A plurality of tasks are performed simultaneously based on the signal of pre-processing means 20. These include sensor self-monitoring 21, head detection or head tracking, eye location 22, classification of occupants or postures, and detection and locating of the glare zones of the image in block 24. The result is a vector containing different data. This vector 26 includes the sensor status from sensor self-monitoring means 21, occupant classification, posture, head position, eye position, and viewing direction of the vehicle occupant, as well as glare zones and glare intensities.

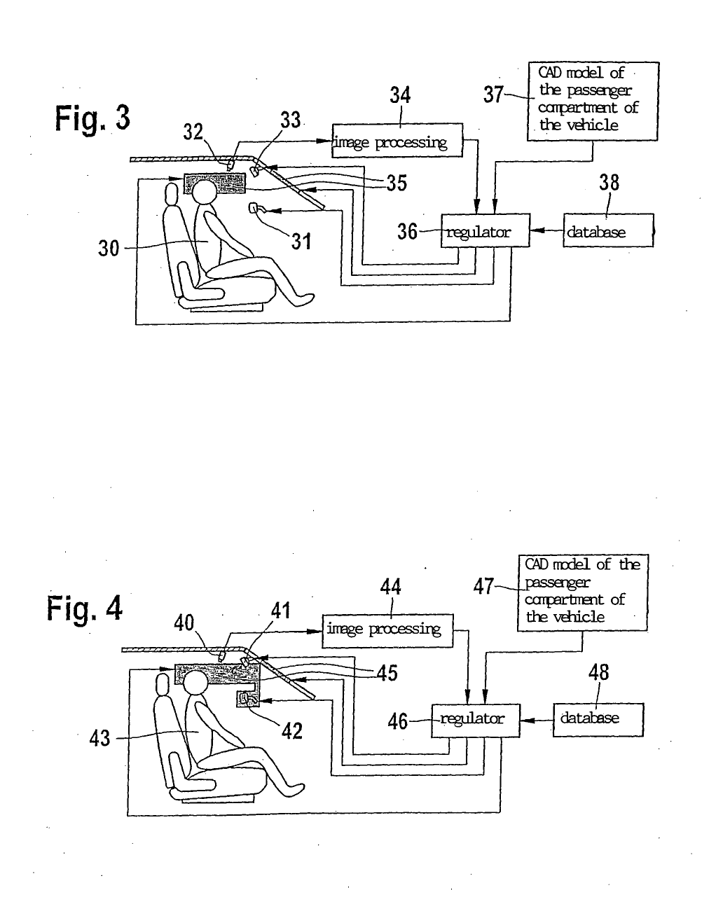

FIG. 3 shows a block diagram of a third example embodiment of the device according to the present invention. A vehicle occupant 30 in a vehicle seat is monitored by an image acquisition sensor 32. Vehicle occupant 30 sees an external rear-view mirror 31 and an internal rear-view mirror 33. An adaptive antiglare means is provided on vehicle window 35 to protect vehicle occupant 30 from glare. The signals of image acquisition sensor 32 are processed by an image processing means 34 to determine the sensor status, the occupant class, position, head position, eye position, and viewing direction of the vehicle occupant, as well as glare zones and glare intensities. This data is supplied to a regulator 36, which also takes into account a CAD model of passenger compartment 37 and data from a database 38. This data includes parameter sets and characteristic curves for activating the antiglare system. Regulator 36 then activates antiglare means 35 as a function of this data, the antiglare means including those of the external and internal rear-view mirrors. CAD model 47 results in better adaptation of the antiglare system regulation to the passenger compartment geometry.

FIG. 4 shows a block diagram of another example embodiment of the device according to the present invention. A vehicle occupant 43 in a vehicle seat is monitored by an image acquisition sensor 40. Vehicle occupant 43 again sees an internal rear-view mirror 41 and an external rear-view mirror 42. An adaptive antiglare means is provided on vehicle window 45 to protect vehicle occupants 43 from glare. The signals of image acquisition sensor 40 are processed by an image processing means 44. The result vector is composed of the sensor status, occupant class, posture, head position, eye position, and viewing direction of the vehicle occupant, as well as glare zones and glare intensities. This data is supplied to a regulator 46, which activates antiglare means 45. However, regulator 46 also takes into account a CAD model of passenger compartment 47 and data from a database 48, which includes parameter sets and characteristic curves for activating the antiglare system. In this case the antiglare means is designed such that the vehicle occupants are protected from indirect glare via the mirrors by appropriate darkening of the relevant areas of the vehicle windows. In this case, simple, non-dimmable mirrors may be used.

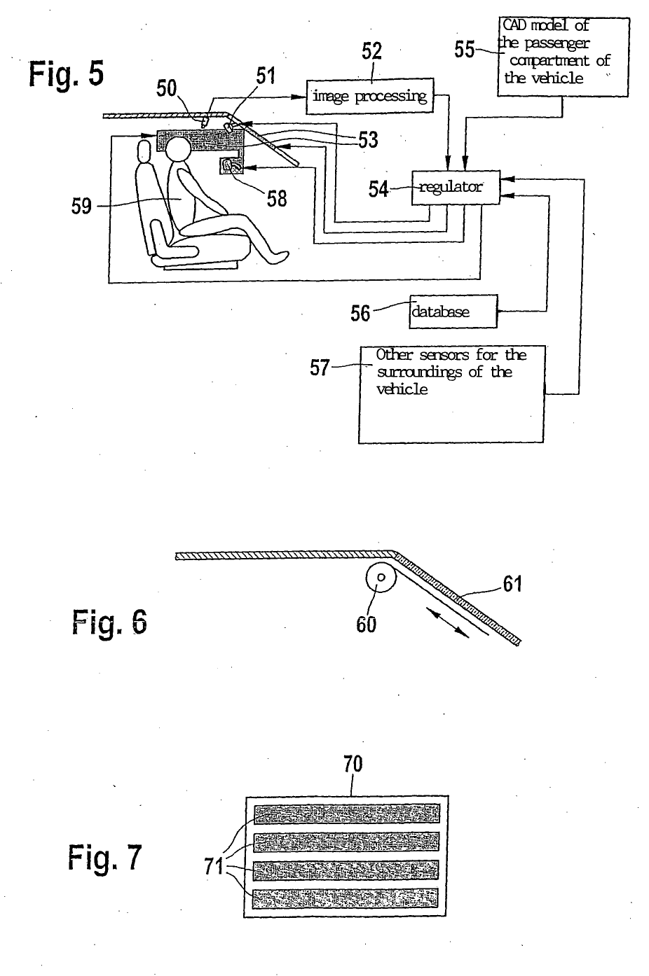

FIG. 5 shows a block diagram of another example embodiment of the device according to the present invention. A vehicle occupant 59 is detected by an image acquisition sensor 50. Vehicle occupant 59 sees an external rear-view mirror 58 and an internal rear-view mirror 51. An adaptive antiglare means 53 is provided to protect vehicle occupant 59 from glare. The signals of image acquisition sensor 50 are processed by image processing means 52 to determine the above-described data. This data is supplied to a regulator 54, which activates antiglare means 53 as a function thereof. However, in addition, the regulator also takes into account a model of the passenger compartment and data of a database 56. Regulator 54 also takes into account data from other sensors such as a surroundings sensor system for the vehicle surroundings.

In addition to this data, sensors for measuring the vehicle velocity and the steering angle and the above-mentioned surroundings sensors may be used as data sources for regulator 54. For example, the dynamics of the regulator may be adjusted via the vehicle velocity and via the surroundings sensor system, for example, when driving in the city or in a tunnel. Steering angle detection allows optimum adjustment of the antiglare system when cornering.

FIG. 6 shows an example of the actuator system of the antiglare means as shutter or blinds 60. The actuator system is situated appropriately in front of a vehicle window 61. FIG. 7 shows a schematic diagram of the electrochromatic glass. In this case, the structure of antiglare means 70 includes individually controllable individual elements 71, which are able to apply an electric voltage to the electrochromatic glass to darken individual areas differently.

In an example embodiment of the present invention, a video camera is provided as an imaging device, which is equipped with antiglare means in such a way that it is sensitive only in a predefined spectral range. In one example embodiment, this sensitive spectral range may include at least one narrow range of the visible spectrum. In another example embodiment, this spectral range may be situated in the infrared range of the spectrum. In order to ensure proper passenger compartment illumination which remains as constant as possible, a light source adapted to the sensitivity range of the image acquisition means may be provided. To further improve the image quality of the image acquisition means, external light effects that interfere with the antiglare system of the vehicle are largely reduced or fully suppressed. For this purpose, the antiglare means situated in the vehicle windows is controlled in such a way that interfering spectral components of the light penetrating the passenger compartment from the outside are filtered. For example, if the image acquisition means is sensitive in the infrared range and, if necessary, illumination means operating in this spectral range are switched to the active mode, the antiglare means situated in the vehicle windows is controlled in such a way that it largely prevents the infrared radiation from penetrating the passenger compartment. However, if an image acquisition means which is sensitive only in a narrow range or several narrow ranges of the visible spectrum is provided, the antiglare means is controlled in such a way that just this narrow range or these narrow ranges of the spectrum are suppressed from the radiation penetrating the passenger compartment from the outside.

In general, it must be ensured that the vision of the vehicle occupants, in particular of the driver, is not impaired by the above-described filtering of the light, so that the driver is able to accurately follow the traffic. Fewer problems are to be expected when partial ranges of the infrared spectrum are suppressed, because these are not perceived by the human eye anyway. When partial ranges of the visible spectrum are suppressed, the antiglare means may be controlled in such a way that it practically functions as a notch filter, which makes the driver register a slight coloring, which, however, is not particularly disturbing. By effectively suppressing interfering spectral components as described above, the passenger compartment is effectively illuminated, from the point of view of the image acquisition means, only by the illumination system tuned to the image acquisition means. This illumination system is advantageously tuned to the sensitivity of the image sensor of the image acquisition means. This results in contrast relationships which are largely independent of the external lighting situations, but are optimized for the image acquisition means, yielding substantially improved passenger compartment detection.

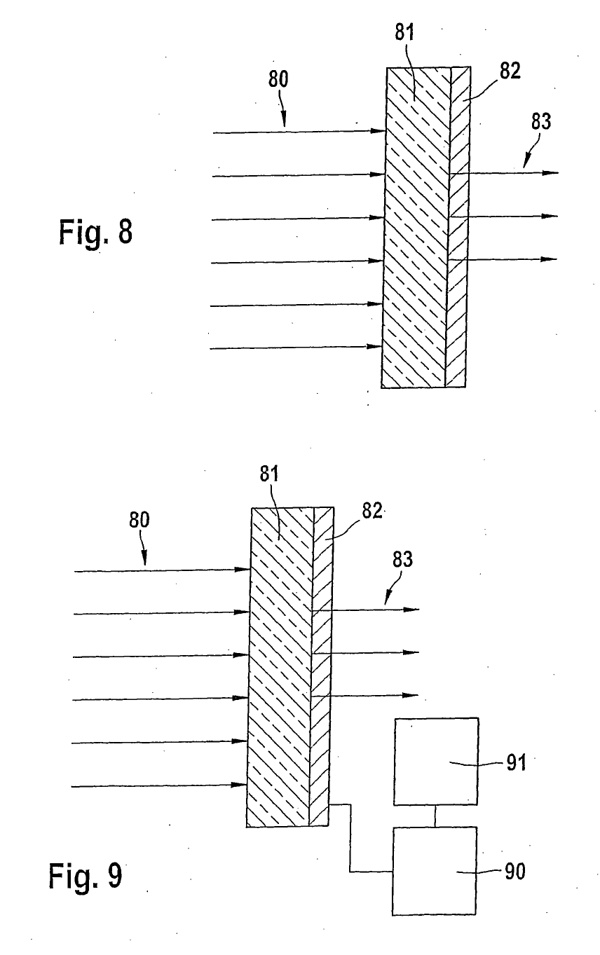

This antiglare system is advantageously applicable with different types of image acquisition means, such as mono and stereo camera systems, monochromatic and color cameras, thermal imaging devices, or, with similarly good results, also with image acquisition means using propagation time measurements such as LIDAR and radar systems. The above-described method makes it possible to achieve better and more reliable functionality of the image acquisition means. Furthermore, these measures allow technically complex and therefore expensive imaging systems having a higher input dynamics (for example, >96 dB) to be avoided. The attenuation of the interfering spectral ranges has such a magnitude that it allows the dynamics of the image acquisition means to be reduced to approximately 8 bits (<approx. 48 dB). In this case, inexpensive components already available from mass production may be used for the image acquisition means. This allows the system costs to be substantially reduced, which, in turn, results in these useful safety-enhancing systems finding widespread use. This embodiment of the present invention is further elucidated below with reference to FIGS. 8 and 9. FIGS. 8 and 9 show as an example a vehicle window 81, which has a layer 82 functioning as an antiglare means. In the exemplary embodiment of FIG. 9, this layer 82 is applied to the inside of vehicle window 81 facing the passenger compartment. In another exemplary embodiment of the present invention, however, this layer 81 may also be applied to the outside of vehicle window 81 or integrated into window 81. The latter variant is implementable in a particularly easy manner in connection with a safety glass having a plurality of layers. Layer 82 is connected to a control unit 90. Control unit 90 is in turn connected to at least one sensor 91. Layer 82 is advantageously controllable in such a way that its transmission properties may be affected by appropriate control signals of control unit 90. In particular, the layer is controllable in such a way that it selectively absorbs the light from the outside, which is represented here by arrow 80, so that only a portion of the spectrum, represented here by arrow 83, is able to penetrate the passenger compartment of the vehicle. In this way, effective glare protection may be implemented for the vehicle occupants, in particular for the image acquisition means monitoring the passenger compartment of the vehicle. Therefore, layer 82 advantageously suppresses those components of the spectrum in particular which are located in the sensitivity range of the image acquisition means. Therefore, if the image acquisition means in a system is sensitive in particular in the infrared range of the spectrum, layer 82 filters out this component of the spectrum in particular from the radiation penetrating from the outside. For this purpose, the control unit analyzes signals of at least one sensor 91, which detects the radiation penetrating the passenger compartment of the vehicle (arrow 83).

In a simpler example embodiment of the present invention, the filtering properties of the vehicle windows are not dynamically controllable, but are constant. This effect may be achieved in a simple manner as early as during the manufacturing process of the window panes provided for the vehicle windows by optically coating them or by applying appropriate films having filtering properties to the windows. This simpler example embodiment of the present invention is illustrated in FIG. 8. A vehicle window is again labeled with reference number 81. This vehicle window 81 has a layer 82 having a selective filtering effect. Layer 82 filters the radiation from the outside (arrow 80) in such a way that only a non-interfering component of the spectrum (arrow 83) penetrates the passenger compartment of the vehicle. This embodiment is implementable in a more cost-effective manner, but has the disadvantage compared to the exemplary embodiment illustrated in FIG. 9 that the filtering properties of layer 82 are not dynamically controllable.

1-19. (canceled)

20. An antiglare system for a vehicle, comprising:
an antiglare mechanism; and
a control device for controlling the antiglare mechanism, the control device including at least one image acquisition mechanism, wherein the control device controls the antiglare mechanism as a function of a signal derived from the image acquisition mechanism, and wherein the signal derived from the image acquisition mechanism includes data regarding at least one of a head position and a face-covering of at least one vehicle occupant.

21. The antiglare system as recited in claim 20, wherein the data regarding the head position includes an eye position of the at least one vehicle occupant.

22. The antiglare system as recited in claim 20, wherein the data regarding the head position includes an occupant class of the at least one vehicle occupant.

23. The antiglare system as recited in claim 22, wherein the at least one image acquisition mechanism is a stereo video sensor for monitoring a passenger compartment of the vehicle.

24. The antiglare system as recited in claim 22, wherein the control device is operatively coupled to a restraint system for the at least one vehicle occupant.

25. The antiglare system as recited in claim 20, wherein the face-covering is a pair of sunglasses.

26. The antiglare system as recited in claim 20, wherein the control device identifies at least one shadow edge.

27. The antiglare system as recited in claim 20, wherein the control device identifies a light intensity.

28. The antiglare system as recited in claim 26, wherein the control device generates the signal derived from the image acquisition mechanism as a function of activation of the antiglare mechanism.

29. The antiglare system as recited in claim 27, wherein the control device generates the signal derived from the image acquisition mechanism as a function of activation of the antiglare mechanism.

30. The antiglare system as recited in claim 29, wherein the control device regulates the brightness of the image acquisition mechanism as a function of the signal derived from the image acquisition mechanism.

31. The antiglare system as recited in claim 27, wherein the control device controls activation of the antiglare mechanism, and wherein the control device takes into account a model of the passenger compartment of the vehicle when activating the antiglare mechanism.

32. The antiglare system as recited in claim 27, wherein the control device controls activation of the antiglare mechanism, and wherein the control device takes into account a second signal from an additional sensor system when activating the antiglare mechanism.

33. An antiglare system for a vehicle, comprising:
an antiglare mechanism; and
a control device for controlling the antiglare mechanism, the control device including at least one image acquisition mechanism, wherein the control device controls the antiglare mechanism as a function of a first signal of the image acquisition mechanism, and wherein the image acquisition mechanism is sensitive only to a partial range of the spectrum, and wherein the antiglare mechanism reduces penetration of light into the vehicle for the partial range of the spectrum to which the image acquisition mechanism is sensitive.

34. The antiglare system as recited in claim 33, wherein the antiglare mechanism is bonded to a window of the vehicle.

35. The antiglare system as recited in claim 33, wherein the control device controls the antiglare mechanism to varying degrees of glare reduction.

36. The antiglare system as recited in claim 33, wherein the antiglare mechanism has a predefined attenuation value for a predefined spectral range.

37. The antiglare system as recited in claim 33, wherein the image acquisition mechanism is sensitive to the infrared range of the spectrum.

38. The antiglare system as recited in claim 33, wherein the image acquisition mechanism is sensitive to at least a narrow portion of the visible range of the spectrum.

39. The antiglare system as recited in claim 33, further comprising:
an illumination mechanism for illuminating the passenger compartment of the vehicle in the partial range of the spectrum to which the image acquisition mechanism is sensitive.
